(19) United States
(12) Patent Application Publication
(10) Pub. No.: US 2025/0292776 A1
(43) Pub. Date: Sep. 18, 2025

(54) SPEAKER EMBEDDING-BASED SPEAKER ADAPTATION METHOD AND SYSTEM GENERATED BY USING GLOBAL STYLE TOKENS AND PREDICTION MODEL

(71) Applicant: IUCF-HYU (INDUSTRY-UNIVERSITY COOPERATION FOUNDATION HANYANG UNIVERSITY), Seoul (KR)

(72) Inventors: Joon-Hyuk CHANG, Seoul (KR); Jaeuk LEE, Seoul (KR)

(73) Assignee: IUCF-HYU (INDUSTRY-UNIVERSITY COOPERATION FOUNDATION HANYANG UNIVERSITY), Seoul (KR)

(21) Appl. No.: 18/859,339

(22) PCT Filed: May 18, 2023
(86) PCT No.: PCT/KR2023/006781

§ 371 Date: Oct. 23, 2024

(30) Foreign Application Priority Data
May 31, 2022 (KR) 10-2022-0066636

(51) Int. Cl. G10L 17/02; G10L 13/033

(52) U.S. Cl. CPC G10L 17/02; G10L 13/033

(57) ABSTRACT

Disclosed are a speaker embedding-based speaker adaptation method and system generated by using global style tokens and a prediction model. The speaker adaptation method performed by the speaker adaptation system, according to an embodiment, may comprise the steps of: generating a plurality of speaker embeddings representing the tone of a speaker from a speaker embedding by using a voice transformation model including a global style token mechanism; and predicting the final speaker embedding representing a new speaker through similarity comparison between a new speaker embedding predicted by using a prediction model for predicting a speaker embedding and the plurality of generated speaker embeddings.

### TECHNICAL FIELD

The following description relates to a speaker adaptation technology.

### BACKGROUND ART

A global style token (GST) is a technology that extracts a speaker style based on attention. FIG. 1 is a diagram for describing an operation of extracting style embeddings from a global style token. A potential vector that represents a speaker style that has been extracted based on the global style token is used in a way to be combined with an encoder output of a text-to-speech (TTS) model consisting of an encoder and a decoder. A reference encoder extracts a feature vector from an audio. The extracted feature vector is used as a query in attention. In FIG. 1, the attention assigns weights to A, B, C, and D. A, B, C, and D are weight-summed to become style embeddings.

A conventional technology has problems in that it requires a large amount of data having a minute unit for speaker adaptation and the entire model needs to be fine-tuned.

Non-patent document 1: Y. Wang, D. Stanton, Y. Zhang, R. S.-Ryan, E. Battenberg, J. Shor, Y. Xiao, F. Ren, Y. Jia and R. A. Saurous, “Style tokens: unsupervised style modeling, control and transfer in end-to-end speech synthesis,” in Proc. Advances in Neural Information Processing Systems (NeurIPS) 2018, pp. 5180-5189)

### DISCLOSURE

### Technical Problem

A speaker adaptation method and system based on speaker embeddings that are generated based on a global style token and a prediction model may be provided.

A method and system for generating a plurality of speaker embeddings that represents a tone of a speaker from speaker embeddings by using a voice conversion model included in a global style token mechanism may be provided.

A method and system for searching for a final speaker embedding that represents a new speaker through a comparison of similarity between a new speaker embedding and a plurality of speaker embeddings that are predicted by using a prediction model that predicts speaker embeddings may be provided.

### Technical Solution

A speaker adaptation method which is performed by a speaker adaptation system may include steps of generating a plurality of speaker embeddings that represents a tone of a speaker from a speaker embedding by using a voice conversion model including a global style token (GST) mechanism, and predicting a final speaker embedding that represents a new speaker based on a comparison of similarity between a new speaker embedding that is predicted by using a prediction model that predicts a speaker embedding and the plurality of generated speaker embeddings.

The step of generating may include steps of constructing the voice conversion model including the global style token mechanism, extracting the speaker embedding corresponding to a speaker ID through a speaker embedding table by using the constructed voice conversion model, predicting a variance of a Gaussian distribution for the extracted speaker embedding through the global style token mechanism, and the extracted speaker embedding is a potential vector that represents a tone of each speaker.

The step of generating may include steps of extracting a variance of each speaker by using the extracted speaker embedding in attention of the global style token mechanism as a query, and obtaining a Gaussian noise vector having the extracted variance by multiplying noise sampled from the Gaussian distribution by the extracted variance.

The step of generating may include a step of generating a plurality of speaker embeddings that represents a tone of one speaker by adding the obtained Gaussian noise vector to the extracted speaker embedding.

The step of predicting the final speaker embedding that represents the new speaker may include steps of constructing the prediction model that predicts the speaker embedding, and receiving a selected speaker embedding, among a plurality of speaker embeddings generated in the constructed prediction model, and a fundamental frequency of the new speaker.

The step of predicting the final speaker embedding that represents the new speaker may include a step of selecting a speaker having a pitch contour of the new speaker, among trained speakers, through the voice conversion model.

The step of predicting the final speaker embedding that represents the new speaker may include a step of selecting a speaker having a low value of Kullback-Leibler (KL) divergence as the speaker embedding based on a comparison of similarity using the KL divergence between the pitch contour of the new speaker and pitch contours of the trained speakers.

The step of predicting the final speaker embedding that represents the new speaker may include steps of extracting a pitch embedding by inputting a pitch contour of the new speaker to a pitch embedding table, generating a global pitch embedding through a convolutional neural network (CNN) and mean pooling for the extracted pitch embedding, and generating a new speaker embedding that represents a tone of the new speaker by combining the global pitch embedding and the selected speaker embedding through the prediction model.

The step of predicting the final speaker embedding that represents the new speaker may include steps of predicting a Gaussian distribution of the new speaker by inputting the generated new speaker embedding to the global style token as a query, and extracting a plurality of new speaker embeddings from the Gaussian distribution.

The step of predicting the final speaker embedding that represents the new speaker may include a step of selecting one new speaker embedding capable of most similarly representing an actual voice of the new speaker, among the plurality of extracted new speaker embeddings.

The step of predicting the final speaker embedding that represents the new speaker may include steps of selecting noise having a smallest difference from an actual voice from the Gaussian distribution of the new speaker, and obtaining a speaker embedding that represents the new speaker by adding the selected noise to the new speaker embedding.

The step of predicting the final speaker embedding that represents the new speaker may include a step of generating the final speaker embedding that represents the new speaker by fine-tuning a speaker embedding that represents the obtained new speaker as data of the new speaker.

There may be provided a computer program that is stored in a non-transitory computer-readable recording medium in order to execute the speaker adaptation method in the speaker adaptation system.

A speaker adaptation system may include a speaker embedding generation unit configured to generate a plurality of speaker embeddings that represents a tone of a speaker from a speaker embedding by using a voice conversion model including a global style token (GST) mechanism, and a speaker embedding prediction unit configured to predict a final speaker embedding that represents a new speaker based on a comparison of similarity between a new speaker embedding that is predicted by using a prediction model that predicts a speaker embedding and the plurality of generated speaker embeddings.

### Advantageous Effects

It is suitable to represent a tone unique to each speaker because characteristics are extracted at a speaker level.

A voice of a new speaker can be well represented although a parameter is not fine-tuned.

### DESCRIPTION OF DRAWINGS

FIG. 1 is a diagram for describing an operation of extracting a speaker embedding from a global style token.

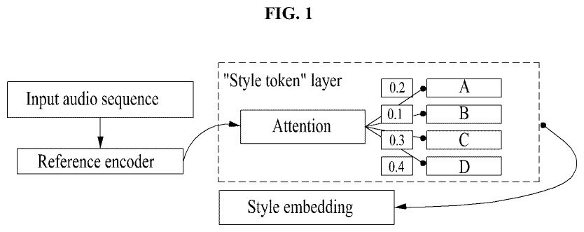

FIG. 2 is a diagram for describing an operation of extracting a speaker embedding from a speaker embedding table.

FIG. 3 is a diagram for describing an operation of a voice conversion model in an embodiment.

FIG. 4 is a diagram for describing a distribution of speaker embeddings in an embodiment.

FIG. 5 is a diagram for describing an operation of a prediction model in an embodiment.

FIG. 6 is a diagram for describing a new speaker adaptation operation in an embodiment.

FIG. 7 is a block diagram for describing a construction of a speaker adaptation system in an embodiment.

FIG. 8 is a flowchart for describing a speaker adaptation method in an embodiment.

FIG. 9 is a diagram for describing a general fine-tuning operation in an embodiment.

FIG. 10 is a diagram for describing an operation of measuring a distance between a new speaker and speakers who are already used for training, based on pitch contours in an embodiment.

### BEST MODE

Hereinafter, embodiments are described in detail with reference to the accompanying drawings.

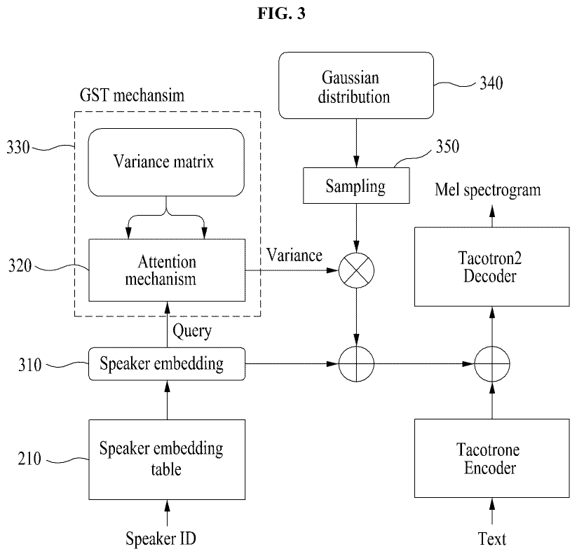

FIG. 3 is a diagram for describing an operation of a voice conversion model in an embodiment.

A speaker adaptation system may construct a voice conversion model (e.g., a TTS) by applying a GST mechanism to multi-speaker Tacotron2 (a speaker embedding table+Tacotron2). A process of extracting a speaker embedding 310 corresponding to a speaker ID from a speaker embedding table 210 is as follows.

$${e}_{i} = Eo ( i ) \cdot {T}_{S} \qquad Equation 1$$

wherein eᵢ, i, and Tₛ indicate an i-th speaker embedding, the speaker ID, and the speaker embedding table. E₀ indicates one-hot encoding, and converts i into one-hot vector.

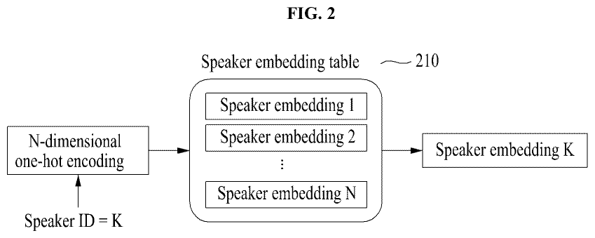

As illustrated in FIG. 2, the speaker adaptation system extracts the speaker embedding 310 from the speaker embedding table 210, and may use the extracted speaker embedding 310 in a global style token (GST) (300) mechanism. The existing global style token extracts a style embedding. In contrast, in an embodiment, the global style token 330 is used to predict a variance of a Gaussian distribution. The speaker embedding 310 is a potential vector that represents a tone of each speaker. The speaker adaptation system may extract a variance of each speaker by using the speaker embedding 310 as a query for attention 320. The speaker adaptation system may extract a variance from the speaker embedding 310 by using the global style token (330) mechanism, and may obtain a Gaussian noise vector having the extracted variance by multiplying, by the extracted variance, noise sampled (350) from the Gaussian distribution 340. Such a process may be represented as in Equation 2.

$${e}_{i}^{′} = {e}_{i} + z \cdot ( softmax ( {e}_{i} \cdot {V}^{T} ) \cdot V ) \qquad Equation 2$$

wherein eᵢ is an i-th speaker embedding extracted from a speaker embedding, V is a variance matrix having a dimension of 10×dₑ, and z is a noise vector sampled from a Gaussian distribution (N(O,I)), dₑ is a dimension of the speaker embedding, and e′ᵢ is a proposed speaker embedding that is used in speaker conditioning.

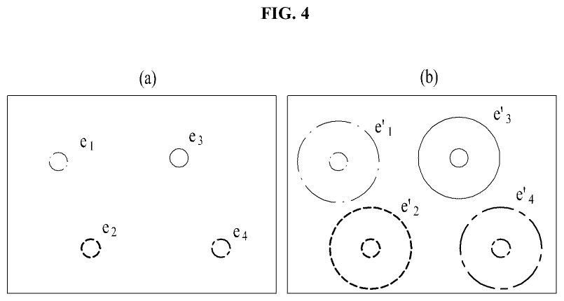

The speaker adaptation system may generate a speaker embedding having a wide distribution with respect to each speaker, not a single speaker embedding per speaker. The speaker adaptation system may help new speaker adaptation by expanding a potential vector on which each tone may be represented. The speaker adaptation system also has a similar effect in voice duplication through a speaker encoder, but the speaker encoder is an embedding of an utterance level. The speaker adaptation system shows stable performance through an embedding of a speaker level. After multiple speakers are trained, a wide distribution of a speaker embedding may be obtained as illustrated in FIG. 4.

FIG. 4 is a diagram for describing a distribution of speaker embeddings in an embodiment.

FIG. 4 is a diagram that represents distributions of the existing speaker embeddings and speaker embeddings that are proposed in an embodiment. A figure (FIG. 4(a)) on the left side illustrates the existing speaker embeddings. A figure (FIG. 4(b)) on the right side illustrates speaker embeddings having a distribution expanded through a method that is proposed in an embodiment. When a distribution of speaker embeddings is expanded, in the method (algorithm) that is proposed in an embodiment, the speaker embeddings are more advantageous than the existing speaker embeddings. In this case, the speaker adaptation system may provide a prediction model for predicting speaker embeddings which may include a voice of a new speaker to some extent.

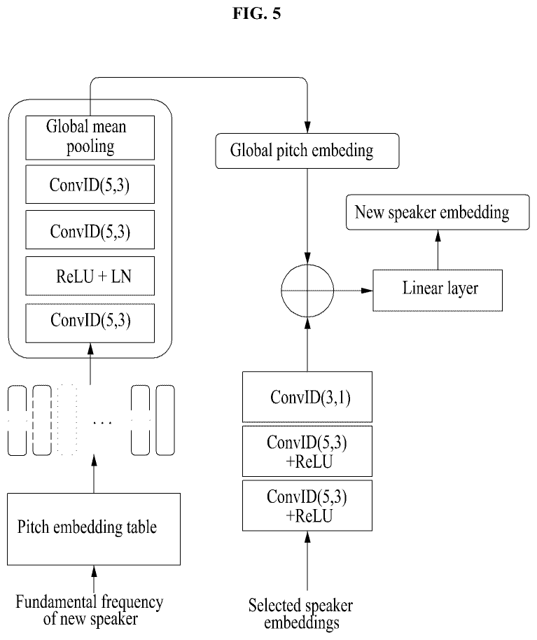

FIG. 5 is a diagram for describing an operation of the prediction model in an embodiment.

FIG. 5 illustrates a structure of the prediction model for generating a new speaker embedding. In ID convolution (m, n), a kernel size (filter size) and a stride in the ID convolution mean m and n, respectively. LN means layer normalization.

The speaker adaptation system may predict a new speaker embedding. In order to predict the new speaker embedding, the speaker adaptation system may use a speaker embedding that is selected from a trained speaker embedding table and a pitch contour that is obtained from a reference audio of a new speaker. The speaker adaptation system may select a speaker embedding based on the pitch contour.

The speaker adaptation system may provide the prediction model capable of predicting a speaker embedding which may include a voice of a new speaker to some extent. The input of the prediction model includes a selected speaker embedding and a fundamental frequency of a new speaker.

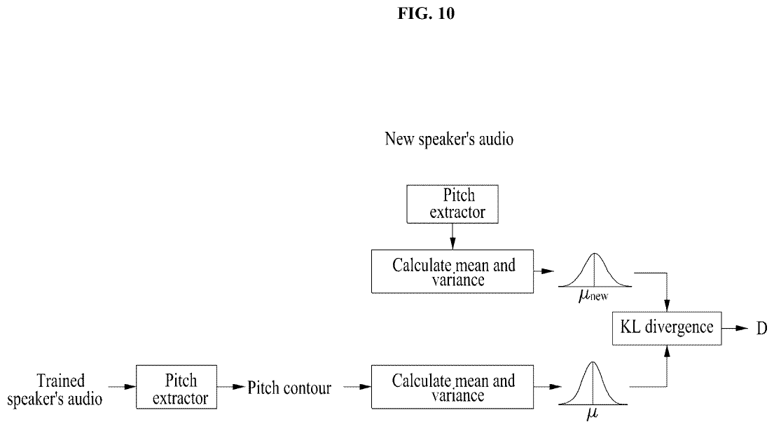

FIG. 10 is a diagram for describing an operation of measuring a distance between a new speaker and speakers who have already been used, based on pitch contours. The speaker adaptation system may select a speaker having a pitch contour similar to that of a new speaker, among the existing trained speakers, based on pitch contours. The speaker adaptation system may select a speaker based on pitch contours by using Kullback-Leibler (KL) divergence. A method of selecting a speaker by using the KL divergence may be represented as in Equation 3.

$${D}_{i} = KL ( N ( {μ}_{new} , {σ}_{new}^{2} ) \vert \vert N ( {μ}_{i} , {σ}_{i}^{2} ) ) \qquad Equation 3$$

The speaker adaptation system may calculate similarity between a pitch contour of a new speaker and a pitch contour of an i-th speaker, among trained speakers, as the KL divergence through Equation 3. The pitch contour means a pitch sequence for a fundamental frequency that is extracted from voice data every frame. A mean and a variance are calculated from the pitch contour. A Gaussian distribution is substituted into the calculated mean and variance. In other words, the calculated mean and variance may be set as values corresponding to the Gaussian distribution.

Accordingly, the speaker adaptation system may calculate similarity between a Gaussian distribution of a new speaker and a Gaussian distribution of trained speakers (speakers that have been used in the training of multiple speakers before fine-tuning) as the KL divergence. In this case, this means that the Gaussian distributions are similar as the value of the calculated KL divergence is reduced.

In an embodiment, a plurality of persons (e.g., 11 persons) is selected, among trained speakers, in the order in which the values of the KL divergence are small, which becomes the selected speaker embeddings in FIG. 5. The speaker adaptation system may extract a pitch embedding when the pitch contour of the new speaker is input to the pitch embedding table, and may generate a global pitch embedding through a convolutional neural network (CNN) and mean pooling for the extracted pitch embedding. The speaker adaptation system may predict a new speaker embedding by using the global pitch embedding and the selected speaker embedding through the prediction model. A training process for the prediction model is similar to the prediction of the new speaker embedding. After one of speaker embeddings that are obtained through multi-speaker training is set as a target to be predicted by the prediction model, a plurality (e.g., 11) of speaker embeddings may be selected based on the values of the KL divergence having a target and used as an input. Furthermore, a loss function for the training may be set as an L2 loss along with the target.

The speaker adaptation system may predict a Gaussian distribution of a new speaker by inputting a new speaker embedding to a global style token as a query, and may extract a plurality of new speaker embeddings from the Gaussian distribution. The speaker adaptation system may select one new speaker embedding capable of most similarly representing an actual voice of the new speaker, among the plurality of extracted new speaker embeddings. A method of selecting the new speaker embedding may be represented as in Equation 4.

$${e}_{np}^{i} = {e}_{n} + arg {min}_{{z}_{new}} {( {M}_{r} - {M}_{s} )}^{2} \qquad Equation 4$$

Wherein, eₙ is a predicted new speaker embedding, and Z_{new} is a distribution of new speaker embedding that are predicted by the global style token. The speaker adaptation system may select noise having the smallest difference with the actual voice within the predicted distribution, and may obtain e′ₙ that best represents a new speaker by adding the selected noise and eₙ. Furthermore, the speaker adaptation system may generate a speaker embedding that accurately represents the new speaker by fine-tuning e′ₙ as the data of the new speaker.

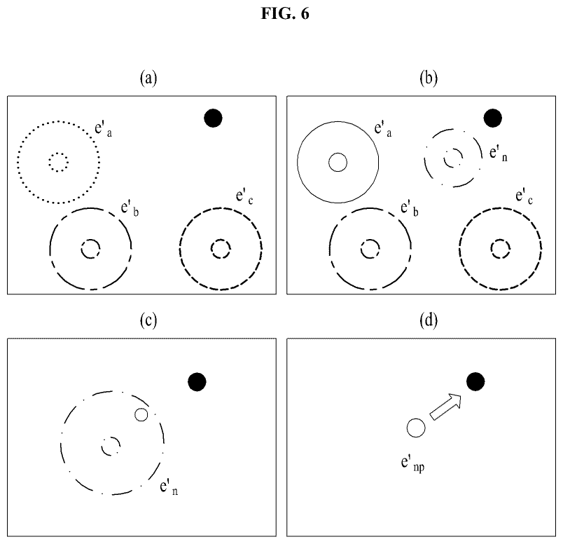

FIG. 6 is a diagram for describing a new speaker adaptation operation in an embodiment.

In FIG. 6(a), e′ₐ, e′_{b}, and e′_{c} are each a distribution of selected speaker embeddings. FIG. 6(b) is distributions of new speaker embeddings that are estimated by the prediction model and the global style token mechanism. In FIG. 6(c), a point indicated by a solid line is a point that is close to an actual new speaker within a distribution of e′ₙ. FIG. 6(d) illustrates that the point of the solid line e′ₙₚ has been fine-tuned of as new data, and a point at the top on the right side thereof is a point of a potential space indicating a tone of a new speaker.

As illustrated in FIG. 6, a speaker adaptation process may include four steps. First, the value of KL divergence between a trained speaker and a new speaker may be calculated. A speaker may be selected in a low dimension having the calculated value of the KL divergence. Next, the prediction model may predict a new speaker embedding by using a selected speaker embedding and a pitch contour of a new speaker. Furthermore, the predicted new speaker embedding may be input to the global style token mechanism, so that a distribution of new speaker embeddings may be obtained. Thereafter, a point that is the closest to a tone of the new speaker within the obtained distribution is searched for. In this case, the retrieved point is indicated as e′ₙₚ in FIG. 6(d). Fine-tuning is not present up to such a process. In the last process, e′ₙₚ and e′ₙₚ another part (e.g., a decoder) may be fine-tuned together.

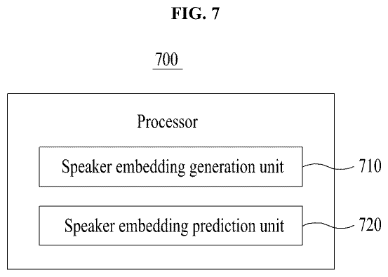

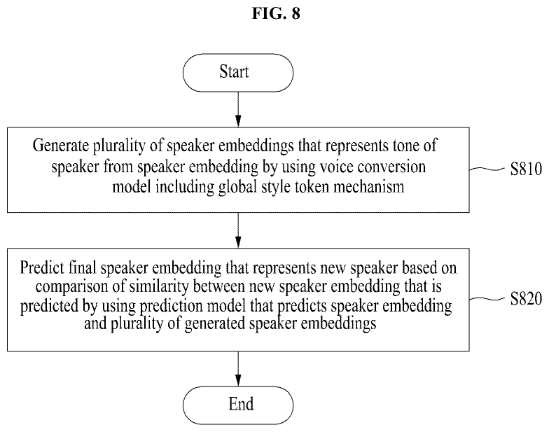

FIG. 7 is a block diagram for describing a construction of the speaker adaptation system in an embodiment. FIG. 8 is a flowchart for describing a speaker adaptation method in an embodiment.

A processor of the speaker adaptation system 100 may include a speaker embedding generation unit 710 and a speaker embedding prediction unit 720. Such components of the processor may be expressions of different functions that are performed by the processor based on a control command that is provided by a program code stored in the speaker adaptation system. The processor and the components of the processor may control the speaker adaptation system so that the speaker adaptation system performs steps (S810 to S820) included in the speaker adaptation method of FIG. 8. In this case, the processor and the components of the processor may be implemented to execute instructions according to a code of an operating system that is included in memory and a code of at least one program.

The processor may load, onto the memory, a program code stored in a file of a program for the speaker adaptation method. For example, when the program is executed in the speaker adaptation system, the processor may control the speaker adaptation system so that the speaker adaptation system loads a program code from a file of the program onto the memory under the control of the operating system. In this case, the speaker embedding generation unit 710 and the speaker embedding prediction unit 720 may be different functional expressions of the processor for executing the steps (S810 to S820) after executing instructions of a part corresponding to the program code loaded onto the memory.

In step S810, the speaker embedding generation unit 710 may generate a plurality of speaker embeddings that represents a tone of a speaker from a speaker embedding by using a voice conversion model including the global style token mechanism. The speaker embedding generation unit 710 may construct the voice conversion model including the global style token mechanism, may extract the speaker embedding corresponding to a speaker ID through the speaker embedding table by using the constructed voice conversion model, and may predict a variance of a Gaussian distribution for the extracted speaker embedding through the global style token mechanism. The speaker embedding generation unit 710 may extract the variance of each speaker by using the extracted speaker embedding in the attention of the global style token mechanism as a query, and may obtain a Gaussian noise vector having the extracted variance by multiplying noise sampled from the Gaussian distribution by the extracted variance. The speaker embedding generation unit 710 may generate a plurality of speaker embeddings that represents a tone of one speaker by adding the obtained Gaussian noise vector to the extracted speaker embedding.

In step S820, the speaker embedding prediction unit 720 may predict a final speaker embedding that represents a new speaker based on a comparison of similarity between a new speaker embedding that is predicted by using the prediction model that predicts a speaker embedding and the plurality of generated speaker embeddings. The speaker embedding prediction unit 720 may construct the prediction model that predicts the speaker embedding, and may receive a speaker embedding that is selected, among a plurality of speaker embeddings generated in the constructed prediction model, and a fundamental frequency of the new speaker. The speaker embedding prediction unit 720 may select a speaker having a pitch contour of the new speaker, among speakers trained through the voice conversion model. The speaker embedding prediction unit 720 may select a speaker having a low value of Kullback-Leibler (KL) divergence as a speaker embedding through a comparison of similarity using the KL divergence between the pitch contour of the new speaker and pitch contours of the trained speakers. The speaker embedding prediction unit 720 may extract a pitch embedding by inputting the pitch contour of the new speaker to the pitch embedding table, may generate a global pitch embedding through a convolutional neural network (CNN) and mean pooling for the extracted pitch embedding, and may generate a new speaker embedding that represents a tone of the new speaker by combining the global pitch embedding and the selected speaker embedding through the prediction model. The speaker embedding prediction unit 720 may predict a Gaussian distribution of the new speaker by inputting the generated new speaker embedding to the global style token as a query, and may extract a plurality of new speaker embeddings from the Gaussian distribution. The speaker embedding prediction unit 720 may select one new speaker embedding capable of most similarly representing an actual voice of the new speaker, among the plurality of extracted new speaker embeddings. The speaker embedding prediction unit 720 may select noise having the smallest difference from the actual voice from the Gaussian distribution of the new speaker, and may obtain a speaker embedding that represents the new speaker by adding the selected noise to the new speaker embedding. The speaker embedding prediction unit 720 may generate the final speaker embedding that represents the new speaker by fine-tuning a speaker embedding that represents the obtained new speaker as the data of the new speaker.

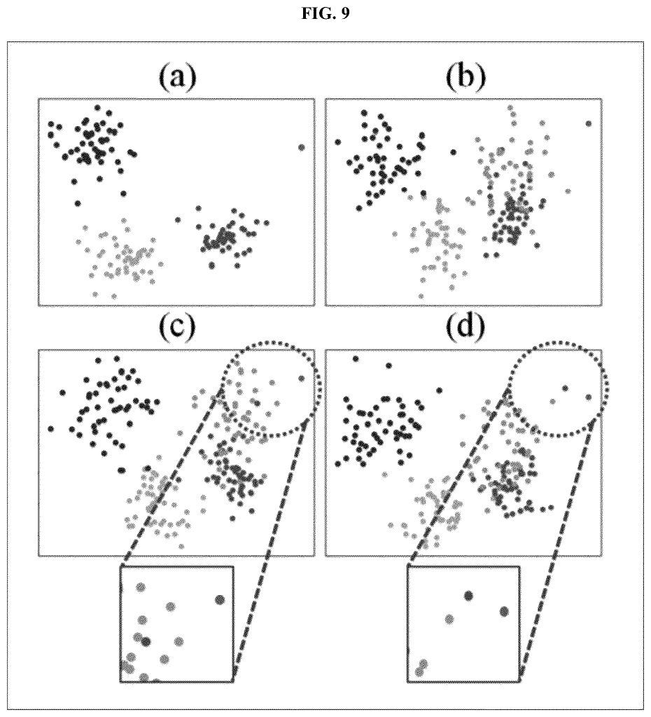

FIG. 9 is a diagram for describing a general fine-tuning operation in an embodiment.

FIG. 9(a) is a form when speakers (blue, yellow, and green) similar to a new speaker (red) are selected. FIG. 9(b) is a form in which the prediction model predicts (mint) an embedding of the new speaker. FIG. 9(c) is a form in which a distribution is predicted in the predicted embedding by using the global style token and an embedding (purple) that best represents a tone of the new speaker within the predicted distribution. FIG. 9(d) illustrates a form in which an actual speaker has become very close when the embedding that best represents the tone is fine-tuned.

For example, in order to experiment performance of speaker adaptation, VCTK and LibriTTS may be used as data sets, and Tacotron2 may be used as a voice synthesis model. A loss function for the training of Tacotron2 is Lᵣ+Lₛₜₒₚ. Lᵣ is a reconstruction loss, and Lₛₜₒₚ is binary cross entropy for a stop token. A variance matrix may consist of 10 variance embeddings and 32 weights per embedding. A learning rate is 0.001, and Adam may be used as an optimizer. In order to fine-tune a new speaker, data having a length of 40 seconds may be used.

Table 1 is the results of naturalness & similarity MOS using a 95% reliability section of each method in Tacotron2.

| Method | Naturalaness | Similarity |
|---|---|---|
| Ground truth | 4.51 ± 0.09 | 4.42 ± 0.06 |
| Speaker embedding (vanilla) | 3.34 ± 0.08 | 2.93 ± 0.11 |
| Style embedding (GST) | 3.50 ± 0.11 | 3.27 ± 0.09 |
| Speaker embedding (ours) | 3.53 ± 0.10 | 3.51 ± 0.07 |
| —(vanilla) | — | — |
| GST mechanism (GST) | 3.58 ± 0.11 | 3.36 ± 0.07 |
| GST mechanism (ours) | 3.65 ± 0.09 | 3.59 ± 0.11 |
| Decoder (vanilla) | 3.60 ± 0.06 | 3.57 ± 0.10 |
| Decoder (GST) | 3.64 ± 0.08 | 3.62 ± 0.09 |
| Decoder (ours) | 3.63 ± 0.10 | 3.74 ± 0.08 |
| The entire (vanilla) | 3.69 ± 0.08 | 3.68 ± 0.12 |
| The entire (GST) | 3.68 ± 0.06 | 3.85 ± 0.08 |
| The entire (ours) | 3.69 ± 0.07 | 3.91 ± 0.09 |

The existing global style token is an algorithm that extracts a style of an utterance level. A characteristic of the utterance level is unstable when being used by inputting the utterance level to an actual TTS model. The reason for this is that a style is changed little by little for each sentence that is uttered by the same speaker. In contrast, the method that is proposed in an embodiment is suitable for representing a tone unique to each speaker because characteristics are extracted in a speaker level.

In the existing researches, if a TTS model is fine-tuned as the data of a new speaker, the entire model is fine-tuned or a decoder is fine-tuned (performance is improved as the number of fine-tuned parameters is increased). The entire model or the decoder has many parameters, and thus a large storage space is necessary if the entire model or the decoder is fine-tuned as the data of a new speaker. For example, if the number of new speaker is 100 when the number of parameters of the decoder is 14M, a storage space is necessary for 14M*100 parameters that are fine-tuned as the data of each speaker. However, if the parameters are fine-tuned by the method that is proposed in an embodiment, a voice of a new speaker can be well represented although the parameters are not fine-tuned.

### Mode for Disclosure

The aforementioned device may be implemented with a hardware component, a software component, and/or a combination of a hardware component and a software component. For example, the device and component described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing or responding to an instruction. The processing device may perform an operating system (OS) and one or more software applications that are executed on the OS. Furthermore, the processing device may access, store, manipulate, process, and generate data in response to the execution of software. For convenience of understanding, one processing device has been illustrated as being used, but a person having ordinary knowledge in the art may understand that the processing device may include a plurality of processing elements and/or a plurality of types of processing elements. For example, the processing device may include a plurality of processors or one processor and one controller. Furthermore, another processing configuration, such as a parallel processor, is also possible.

Software may include a computer program, a code, an instruction or a combination of one or more of them, and may configure a processing device so that the processing device operates as desired or may instruct the processing devices independently or collectively. The software and/or the data may be embodied in any type of machine, component, physical device, virtual machine, or computer storage medium or device, or a transmitted signal wave permanently or temporarily, in order to be interpreted by the processing device or to provide an instruction or data to the processing device. The software may be distributed to computer systems that are connected over a network, and may be stored or executed in a distributed manner. The software and the data may be stored in one or more computer-readable recording media.

The method according to an embodiment may be implemented in the form of a program instruction executable by various computer means, and may be stored in a computer-readable medium. The computer-readable recording medium may include a program instruction, a data file, and a data structure alone or in combination. The program instruction recorded on the medium may be specially designed and constructed for an embodiment, or may be known and available to those skilled in the computer software field. Examples of the computer-readable recording medium include magnetic media such as a hard disk, a floppy disk, and a magnetic tape, optical media such as CD-ROM and a DVD, magneto-optical media such as a floptical disk, and hardware devices specially configured to store and execute a program instruction, such as ROM, RAM, and flash memory. Examples of the program instruction include not only machine language code produced by a compiler, but a high-level language code which may be executed by a computer using an interpreter, etc.

As described above, although the embodiments have been described in connection with the limited embodiments and the drawings, those skilled in the art may modify and change the embodiments in various ways from the description. For example, proper results may be achieved although the aforementioned descriptions are performed in order different from that of the described method and/or the aforementioned components, such as a system, a structure, a device, and a circuit, are coupled or combined in a form different from that of the described method or replaced or substituted with other components or equivalents thereof.

Accordingly, other implementations, other embodiments, and the equivalents of the claims fall within the scope of the claims.

1. A speaker adaptation method performed by a speaker adaptation system, the speaker adaptation method comprising steps of:
generating a plurality of speaker embeddings that represents a tone of a speaker from a speaker embedding by using a voice conversion model comprising a global style token (GST) mechanism; and
predicting a final speaker embedding that represents a new speaker based on a comparison of similarity between a new speaker embedding that is predicted by using a prediction model that predicts a speaker embedding and the plurality of generated speaker embeddings.

2. The speaker adaptation method of claim 1, wherein the step of generating comprises steps of:
constructing the voice conversion model comprising the global style token mechanism,
extracting the speaker embedding corresponding to a speaker ID through a speaker embedding table by using the constructed voice conversion model,
predicting a variance of a Gaussian distribution for the extracted speaker embedding through the global style token mechanism, and
the extracted speaker embedding is a potential vector that represents a tone of each speaker.

3. The speaker adaptation method of claim 2, wherein the step of generating comprises steps of:
extracting a variance of each speaker by using the extracted speaker embedding in attention of the global style token mechanism as a query, and
obtaining a Gaussian noise vector having the extracted variance by multiplying noise sampled from the Gaussian distribution by the extracted variance.

4. The speaker adaptation method of claim 3, wherein the step of generating comprises a step of generating a plurality of speaker embeddings that represents a tone of one speaker by adding the obtained Gaussian noise vector to the extracted speaker embedding.

5. The speaker adaptation method of claim 1, wherein the step of predicting the final speaker embedding that represents the new speaker comprises steps of:
constructing the prediction model that predicts the speaker embedding, and
receiving a selected speaker embedding, among a plurality of speaker embeddings generated in the constructed prediction model, and a fundamental frequency of the new speaker.

6. The speaker adaptation method of claim 5, wherein the step of predicting the final speaker embedding that represents the new speaker comprises a step of selecting a speaker having a pitch contour of the new speaker, among trained speakers, through the voice conversion model.

7. The speaker adaptation method of claim 6, wherein the step of predicting the final speaker embedding that represents the new speaker comprises a step of selecting a speaker having a low value of Kullback-Leibler (KL) divergence as the speaker embedding based on a comparison of similarity using the KL divergence between the pitch contour of the new speaker and pitch contours of the trained speakers.

8. The speaker adaptation method of claim 5, wherein the step of predicting the final speaker embedding that represents the new speaker comprises steps of:
extracting a pitch embedding by inputting a pitch contour of the new speaker to a pitch embedding table,
generating a global pitch embedding through a convolutional neural network (CNN) and mean pooling for the extracted pitch embedding, and
generating a new speaker embedding that represents a tone of the new speaker by combining the global pitch embedding and the selected speaker embedding through the prediction model.

9. The speaker adaptation method of claim 8, wherein the step of predicting the final speaker embedding that represents the new speaker comprises steps of:
predicting a Gaussian distribution of the new speaker by inputting the generated new speaker embedding to the global style token as a query, and
extracting a plurality of new speaker embeddings from the Gaussian distribution.

10. The speaker adaptation method of claim 9, wherein the step of predicting the final speaker embedding that represents the new speaker comprises a step of selecting one new speaker embedding capable of most similarly representing an actual voice of the new speaker, among the plurality of extracted new speaker embeddings.

11. The speaker adaptation method of claim 10, wherein the step of predicting the final speaker embedding that represents the new speaker comprises steps of:
selecting noise having a smallest difference from an actual voice from the Gaussian distribution of the new speaker, and
obtaining a speaker embedding that represents the new speaker by adding the selected noise to the new speaker embedding.

12. The speaker adaptation method of claim 11, wherein the step of predicting the final speaker embedding that represents the new speaker comprises a step of generating the final speaker embedding that represents the new speaker by fine-tuning a speaker embedding that represents the obtained new speaker as data of the new speaker.

13. A computer program which is stored in a non-transitory computer-readable recording medium in order to execute the speaker adaptation method according to claim 1 in the speaker adaptation system.

14. A speaker adaptation system comprising:
a speaker embedding generation unit configured to generate a plurality of speaker embeddings that represents a tone of a speaker from a speaker embedding by using a voice conversion model comprising a global style token (GST) mechanism; and
a speaker embedding prediction unit configured to predict a final speaker embedding that represents a new speaker based on a comparison of similarity between a new speaker embedding that is predicted by using a prediction model that predicts a speaker embedding and the plurality of generated speaker embeddings.
